(19) United States
(12) Patent Application Publication
(10) Pub. No.: US 2024/0099378 A1
(43) Pub. Date: Mar. 28, 2024

(54) HEATER ASSEMBLY

(71) Applicant: Philip Morris Products S.A., Neuchatel (CH)

(72) Inventors: Robert EMMETT, Neuchatel (CH); Eva SAADE LATORRE, Colombier (CH)

(73) Assignee: Philip Morris Products S.A., Neuchatel (CH)

(21) Appl. No.: 18/257,779

(22) PCT Filed: Dec. 13, 2021
(86) PCT No.: PCT/EP2021/085525

§ 371 Date: Jun. 15, 2023

(30) Foreign Application Priority Data
Dec. 22, 2020 (EP) 20216428.1

(51) Int. Cl. A24F 40/465; A24F 40/10; A24F 40/42

(52) U.S. Cl. CPC A24F 40/465; A24F 40/10; A24F 40/42

(57) ABSTRACT

A heater assembly for an aerosol-generating system is provided, the heater assembly including: a liquid aerosol-forming substrate storage component; a reservoir of free-flowing liquid aerosol-forming substrate, the reservoir being in fluid communication with the liquid aerosol-forming substrate storage component; and a heating element including a first portion, a second portion, and a further portion, in which the first portion of the heating element is embedded in the liquid aerosol-forming substrate storage component, the second portion of the heating element is not embedded in the liquid aerosol-forming substrate storage component, and the further portion of the heating element is located in the reservoir. An aerosol-generating system including the heater assembly is also provided.

The present disclosure relates to a heater assembly. In particular, the present disclosure relates to a heater assembly for use in an aerosol-generating system. The present disclosure also relates to a method of assembling the heater assembly, a cartridge comprising the heater assembly, and an aerosol-generating system comprising the heater assembly.

In many known aerosol-generating systems, a liquid aerosol-forming substrate is heated and vaporised to form a vapour. The vapour cools and condenses to form an aerosol. In some aerosol-generating systems, such as electrically heated smoking systems, this aerosol is then inhaled by a user.

Typically, the liquid aerosol-forming substrate comprises several compounds which are vaporised when heated. These compounds may have different boiling points. For example, a liquid aerosol-forming substrate may comprise nicotine (with a boiling point of around 247 degrees Celsius at atmospheric pressure) and glycerol (with a boiling point of around 290 degrees Celsius at atmospheric pressure).

When a liquid aerosol-forming substrate with compounds having different boiling points is heated, compounds with lower boiling points may be vaporised before compounds with higher boiling points. Alternatively, or in addition, compounds with lower boiling points may be vaporised at a higher rate than compounds with higher boiling points.

This may be undesirable because interactions and combinations between different compounds may be limited. For example, a liquid aerosol-forming substrate may comprise a nicotine compound and an organic acid compound, these compounds having different boiling points. Both of these compounds may be vaporised. The nicotine in the liquid aerosol-forming substrate may form free base nicotine when it is vaporised. However, it may be desirable to generate an aerosol with nicotine salt rather than free base nicotine. In order to form this nicotine salt, the free base nicotine may be protonated by the vaporised organic acid. However, this protonation may be limited if the organic acid is not vaporised until after nicotine has vaporised, or is vaporised more slowly than is required to protonate a suitable proportion of the free base nicotine.

Further, vaporising some compounds of an aerosol-forming substrate more quickly than others may undesirably cause the properties of the aerosol generated to change over time, for example over the course of a puff on an aerosol-generating system. This may be because, towards the beginning of a puff, when a heating element is activated and rises in temperature, liquid aerosol-forming substrate close to the heating element may reach a first temperature at which a first compound with a lower boiling point is vaporised but a second compound with a higher boiling point is not vaporised. Then, later in the puff, liquid aerosol-forming substrate close to the heating element may reach a second temperature at which the second compound with the higher boiling point is vaporised. However, at this time, much of the first compound in the liquid aerosol-forming substrate close to the heating element may have already been vaporised. Thus, towards the start of a puff, the aerosol generated may comprise a larger proportion of the first compound and, later in the puff, the aerosol generated may comprise a larger proportion of the second compound.

Alternatively, or in addition, the properties of the aerosol generated may change over the course of several puffs. This may occur where compounds of the liquid aerosol-forming substrate are not vaporised at an appropriate rate. For example, a liquid aerosol-forming substrate may comprise X percent by mass of a first compound and Y percent by mass of a second compound. If the liquid aerosol-forming substrate is not vaporised to produce a vapour comprising a mass ratio of the first compound to the second compound of X to Y, then the composition of the liquid aerosol-forming substrate may change as vapour is generated. This may, in turn, lead to a change in the properties of the aerosol generated by the liquid aerosol-forming substrate.

It is an aim of the invention to control the vaporisation of various compounds of a liquid aerosol-forming substrate, where these compounds have different boiling points.

According to an aspect of the present disclosure, there is provided a heater assembly. The heater assembly may be suitable for use in an aerosol-generating system. The heater assembly may comprise a liquid aerosol-forming substrate storage component. The heating element may comprise a first portion. The heating element may comprise a second portion. The first portion of the heating element may be embedded in the liquid aerosol-forming substrate storage component. The second portion of the heating element may be not embedded in the liquid aerosol-forming substrate storage component.

The heater assembly may provide areas of higher temperature, and areas of lower temperature, in the liquid aerosol-forming substrate storage component. Alternatively, or in addition, the heater assembly may provide areas which increase in temperature at a greater rate, and areas which increase in temperature at a lesser rate, in the liquid aerosol-forming substrate storage component.

Advantageously, the heater assembly may improve control of the vaporisation of the different compounds of the liquid aerosol-forming substrate. The heater assembly may result in liquid aerosol-forming substrate compounds with higher boiling points and lower boiling points being vaporised simultaneously at desirable rates. The heater assembly may result in liquid aerosol-forming substrate compounds with higher boiling points and lower boiling points being vaporised in more preferable proportions. The heater assembly may provide generation of an aerosol with a more desirable composition. The heater assembly may provide more consistent generation of an aerosol with desirable properties.

The heating element may comprise a third portion and a fourth portion. The third portion of the heating element may be embedded in the liquid aerosol-forming substrate storage component. The fourth portion may be not embedded in the liquid aerosol-forming substrate storage component.

Advantageously, this may create more areas of higher temperature, and more areas of lower temperature, in the liquid aerosol-forming substrate storage component. Alternatively, or in addition, this may provide more areas which increase in temperature at a greater rate, and more areas which increase in temperature at a lesser rate, in the liquid aerosol-forming substrate storage component. This may lead to liquid aerosol-forming substrate compounds with higher boiling points and lower boiling points being vaporised simultaneously at desirable rates.

The second portion of the heating element may extend between the first portion and the third portion. That is, the second portion of the heating element may connect the first portion of the heating element to the third portion of the heating element. The third portion may be connected to the first portion only via the second portion.

The third portion of the heating element may extend between the second portion and the fourth portion. That is, the third portion of the heating element may connect the second portion of the heating element to the fourth portion of the heating element. The fourth portion may be connected to the second portion only via the third portion.

The heating element, or one, or more than one, or all, of the first portion, the second portion, the third portion, and the fourth portion, may comprise an electrically resistive material. The heater assembly may be configured such that, in use, an electric current is passed through said portion or portions. This may resistively heat said portion or portions. As such, said portion or portions may be configured to be resistively heated.

One, or more than one, or all, of the first portion, the second portion, the third portion, and the fourth portion, of the heating element may be formed from the same material.

One, or more than one, or all, of the first portion, the second portion, the third portion, and the fourth portion, of the heating element may have substantially the same electrical resistivity (measured in Ohm metres). For example, the first portion and the second portion may have the same electrical resistivity. Alternatively, or in addition, the third portion and the fourth portion of the heating element may have the same electrical resistivity. As used here, the term “substantially the same electrical resistivity” is used to mean within 20, 10, or 5 percent of a given electrical resistivity.

The heating element, or one, or more than one, or all, of the first portion, the second portion, the third portion, and the fourth portion, of the heating element may comprise or be formed from any material with suitable electrical and mechanical properties, for example a suitable, electrically resistive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, Constantan, nickel-, cobalt-, chromium-, aluminium-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminium based alloys and iron-manganese-aluminium based alloys. Timetal® is a registered trade mark of Titanium Metals Corporation, 1999 Broadway Suite 4300, Denver Colorado. In composite materials, the electrically resistive material may optionally be embedded in, encapsulated or coated with an insulating material or vice-versa, depending on the kinetics of energy transfer and the external physicochemical properties required. The heating element may comprise a metallic etched foil insulated between two layers of an inert material. In that case, the inert material may comprise Kapton®, all-polyimide or mica foil. Kapton® is a registered trade mark of E.I. du Pont de Nemours and Company, 1007 Market Street, Wilmington, Delaware 19898, United States of America.

The third portion and the fourth portion may be configured to be resistively heated. The third portion and the fourth portion may comprise an electrically resistive material. The first portion and the second portion may be configured to be resistively heated. The first portion and the second portion may comprise an electrically resistive material.

The heating element, or one, or more than one, or all, of the first portion, the second portion, the third portion, and the fourth portion may comprise a susceptor material. The heater assembly may be configured such that, in use, said portion or portions are inductively heated.

For example, the heater assembly may be configured to be used in an aerosol-generating system comprising an inductor, such as an inductor coil. The inductor may be located in an aerosol-generating device having a power supply. The device may be configured to engage with the heater assembly or a cartridge comprising the heater assembly. Alternatively, the inductor may be located in a cartridge comprising the heater assembly. The cartridge may be configured to engage with an aerosol-generating device having a power supply.

The power supply may be configured to pass an alternating current through the inductor in the cartridge, or the inductor in the device, such that the inductor generates a fluctuating electromagnetic field.

The alternating current may have any suitable frequency. The alternating current may be a high frequency alternating current. The term high frequency alternating current may refer to a frequency between 100 kilohertz (kHz) and 30 megahertz (MHz). Where the inductor is a tubular inductor coil, the alternating current may have a frequency of between 500 kilohertz (kHz) and 30 megahertz (MHz). Where the inductor is a flat inductor coil, the alternating current may have a frequency of between 100 kilohertz (kHz), and 1 megahertz (MHz).

The heating element, or one, or more than one, or all, of the first portion, the second portion, the third portion, and the fourth portion, may be located within, or otherwise subjected to, the electromagnetic field generated by the inductor. This may generate eddy currents and hysteresis losses in the susceptor material. This may cause the susceptor material to heat up. Thus, the power supply and the inductor may be configured to inductively heat one, or more than one, or all, of the first portion, the second portion, the third portion, and the fourth portion.

The susceptor material may be, or may comprise, any material that can be inductively heated to a temperature sufficient to generate an aerosol from the aerosol-forming substrate. Preferred susceptor materials may be heated to a temperature in excess of 50, 100, 150, 200, 250, 300, 350, or 400 degrees Celsius. Preferred susceptor materials may comprise a metal or carbon or both a metal and carbon. A preferred susceptor material may comprise a ferromagnetic material, for example ferritic iron, or a ferromagnetic steel or stainless steel. A suitable susceptor element may be, or comprise, one or more of graphite, molybdenum, silicon carbide, stainless steels, niobium, and aluminium. Preferred susceptor materials may comprise, or be formed from, 400 series stainless steels, for example grade 410, or grade 420, or grade 430 stainless steel. Different materials will dissipate different amounts of energy when positioned within electromagnetic fields having similar values of frequency and field strength. Thus, parameters of the susceptor material such as material type and size may be altered to provide a desired power dissipation within a known electromagnetic field.

The third portion and the fourth portion may be configured to be inductively heated. The third portion and the fourth portion may comprise a susceptor material. The first portion and the second portion may be configured to be inductively heated. The first portion and the second portion may comprise a susceptor material.

Advantageously, in an aerosol-generating system which uses inductive heating, no electrical contacts need be formed between the heater assembly and the aerosol-generating device. In addition, the heating element may not need to be electrically joined to other components. This may eliminate the need for solder or other bonding elements. A cartridge incorporating a heater assembly which is configured to be inductively heated may allow production of a cartridge that is simple, inexpensive and robust. Cartridges are typically disposable articles produced in much larger numbers that the aerosol-generating devices with which they operate. Accordingly, reducing the cost of cartridges can lead to significant cost savings for manufacturers. In addition, inductive heating may provide improved energy conversion compared to resistive heating. This is because inductive heating may not have power losses associated with electrical resistance in connections between a resistive heating element and a power supply.

The heating element may have a length, a width, and a thickness. The heating element may comprise a strip of material. The strip may have a length, a width, and a thickness. The width may be perpendicular to the length. The thickness may be perpendicular to the length and the width. The length may be greater than the width. The width may be greater than the thickness.

A cross-section, or cross-sectional area, of the heating element may vary. For example, a cross-section, or cross-sectional area, of the heating element may vary along a length of the heating element.

The heating element may extend between a first end and a second end. For example, the length of the heating element may extend between a first end and a second end. The heating element may have a first cross-sectional area at a first point between the first end and the second end. The heating element may have a second cross-sectional area at a second point between the first point and the second end. The heating element may have a third cross-sectional area at a third point between the second point and the second end. The first cross-sectional area and the third cross-sectional area may each be greater than, or less than, the second cross-sectional area. For example, the first cross-sectional area and the third cross-sectional area may be at least 10, 20, 50, 100, 200, or 500 percent greater than, or at least 10, 20, 30, 40, 50, 60, 70, or 80 percent less than, the second cross-sectional area. Thus, observing how the cross-sectional area of the heating element varies from the first end to the second end of the heating element, the cross-sectional area of the heating element may decrease and then increase. Alternatively, or in addition, the cross-sectional area of the heating element may increase and then decrease.

Varying the cross-section, or cross-sectional area, of the heating element may result in different sections of the heating element simultaneously reaching different temperatures. For example, in a resistive heating element, a section of the heating element having a smaller cross-sectional area may have a larger resistance, and may therefore be resistively heated to a higher temperature.

Advantageously, this may create areas of higher temperature, and areas of lower temperature. Alternatively, or in addition, this may provide areas which increase in temperature at a greater rate, and areas which increase in temperature at a lesser rate, in the liquid aerosol-forming substrate storage component. As explained above, this may lead to liquid aerosol-forming substrate compounds with higher boiling points and lower boiling points being vaporised simultaneously at desirable rates.

A minimum cross-sectional area along a length of the heating element may be at least 10 percent less than a maximum cross-sectional area along the length of the heating element. A minimum cross-sectional area along a length of the heating element may be at least 20, 40, 60, or 80 percent less than a maximum cross-sectional area along a length of the heating element.

A minimum cross-sectional area of the first portion of the heating element may be at least 10, 20, 40, 60, or 80 percent less than a maximum cross-sectional area of the second portion or the fourth portion. Alternatively, or in addition, a minimum cross-sectional area of the third portion of the heating element may be at least 10, 20, 40, 60, or 80 percent less than a maximum cross-sectional area of the second portion or the fourth portion.

A width or a thickness or both the width and the thickness of the heating element may vary along a length of the heating element.

The heating element may weave into and out of the liquid aerosol-forming substrate storage component. The heating element may comprise a strip of material which weaves into and out of the liquid aerosol-forming substrate storage component. The heating element or strip may weave into and out of the liquid aerosol-forming substrate storage component along its length. Thus, tracing along the length of the heating element or strip, the heating element or strip may alternately comprise portions embedded in the liquid aerosol-forming substrate storage component, such as the first portion and the third portion, and portions not embedded in the liquid aerosol-forming substrate storage component, such as the second portion and the fourth portion.

Advantageously, a heater assembly comprising a heating element which weaves into and out of a liquid aerosol-forming substrate storage component may be relatively straightforward to manufacture.

The heating element may comprise one or more of curves, undulations, folds, and corrugations. The first portion of the heating element may comprise one or more of a curve, an undulation, a fold, and a corrugation. The second portion of the heating element may comprise one or more of a curve, an undulation, a fold, and a corrugation. The third portion of the heating element may comprise one or more of a curve, an undulation, a fold, and a corrugation. The fourth portion of the heating element may comprise one or more of a curve, an undulation, a fold, and a corrugation. The fifth portion of the heating element may comprise one or more of a curve, an undulation, a fold, and a corrugation.

Advantageously, curves, undulations, folds, and corrugations in the heating element may allow greater control of the locations of areas of higher temperature and areas of lower temperature. Alternatively, or in addition, curves, undulations, folds, and corrugations in the heating element may allow greater control of the temperature differences between areas of higher temperature and areas of lower temperature. For example, if a higher temperature is desired in a given region of the liquid aerosol-forming substrate storage component, then the heating element may comprise an undulation or corrugation in this region. This may increase the volume or surface area of the heating element in this region, and therefore increase the heat transferred from the heating element to this region.

The heating element may have a first end and a second end. A length of the heating element may extend from the first end to the second end. Where the heating element does not extend directly from the first end to the second, i.e. in a straight line, the heating element may be considered to comprise one or more of curves, undulations, folds, and corrugations.

A curve may refer to a gradual change in direction of the heating element, for example a gradual change in direction of the heating element between the first end and the second end. Thus, a curve may form an arc, or a “C” shape.

A fold may refer to a step change in direction of the heating element, for example a step change in direction of the heating element between the first end and the second end. Thus, a fold may form two sides of a polygon, or a “V” shape.

An undulation may comprise multiple curves. For example, an undulation may refer to a gradual change in direction of the heating element in a first direction, followed by a gradual change in direction of the heating element in another, for example opposite, direction. Thus, an undulation may form a sinusoidal wave, or an “S” shape.

A corrugation may comprise multiple folds. For example, a corrugation may refer to a step change in direction of the heating element, followed by another step change in direction of the heating element. Thus, a corrugation may form three sides of a rectangle, or an “M” shape, or an “N” shape.

Advantageously, the heating element comprising one or more of curves, undulations, folds, and corrugations may simplify the manufacture of a heater assembly having at least one portion of a heating element embedded in a liquid aerosol-forming substrate storage component and at least one portion not embedded in the liquid aerosol-forming substrate storage component. Further, one or more of curves, undulations, folds, and corrugations may allow the heating element to create areas of higher temperature. For example, a portion of the heating element embedded in the liquid aerosol-forming substrate storage component may have a tightly curved “S” shape. The region of the liquid aerosol-forming substrate storage component around this portion of the heating element may be heated to a higher temperature.

The heating element may comprise one or more of irregular undulations and irregular corrugations along a length of the heating element. As used here, the terms irregular undulations and irregular corrugations refer to undulations and corrugations not having a constant amplitude and frequency.

The amplitude of an undulation or corrugation may be measured in a direction which is perpendicular to the length of the heating element. The amplitude of an undulation or corrugation may be measured in a direction of the thickness of the heating element. The amplitude may refer to half of the height difference between a peak, or local maximum, of an undulation or corrugation, and a trough, or local minimum, of the undulation or corrugation.

The frequency of an undulation or corrugation refers to the number of repeated cycles per unit distance, for example per unit distance in a direction of the length of the heating element or in a direction between the first end and the second end of the heating element. This type of frequency is often referred to as spatial frequency. For example, where the heating element comprises regular, sinusoidal waves, the waves are considered undulations and the frequency of those undulations is 1 divided by the wavelength of the waves.

An example of a regular undulation is a predictable, sinusoidal wave having a constant amplitude and frequency.

A frequency of undulations or corrugations of the heating element may vary along a length of the heating element.

An amplitude of undulations or corrugations of the heating element may vary along a length of the heating element.

Advantageously, varying the amplitudes, or frequencies, or both amplitudes and frequencies, may allow greater control of the locations of areas of higher temperature and areas of lower temperature. Alternatively, or in addition, varying the amplitudes, or frequencies, or both amplitudes and frequencies, may allow greater control of the temperature differences between areas of higher temperature and areas of lower temperature.

The heater assembly may comprise a reservoir for storing liquid aerosol-forming substrate. The heater assembly may comprise a reservoir of liquid aerosol-forming substrate.

The liquid aerosol-forming substrate storage component may store, or be configured to store, liquid aerosol-forming substrate.

The liquid aerosol-forming substrate storage component may be in fluid communication with the reservoir. In this case, in use, sections of the heating element which are further from the reservoir of liquid aerosol-forming substrate, or areas in the liquid aerosol-forming substrate storage component around these sections of the heating element, may reach higher temperatures than sections or areas which are closer to the reservoir of liquid aerosol-forming substrate. This is because more heat may be transferred, or heat may be transferred more quickly, from the heating element to the reservoir of liquid aerosol-forming substrate for sections of the heating element which are closer to the reservoir of liquid aerosol-forming substrate.

Advantageously, the liquid aerosol-forming substrate storage component being in fluid communication with the reservoir may allow liquid aerosol-forming substrate which is vaporised and removed from the liquid aerosol-forming substrate storage component to be replenished quickly and automatically.

The liquid aerosol-forming substrate storage component may comprise, or may be, a material soaked with, or a material configured to be soaked with, liquid aerosol-forming substrate. The liquid aerosol-forming substrate storage component may have a fibrous or spongy structure. The liquid aerosol-forming substrate storage component may comprise a capillary material. The liquid aerosol-forming substrate storage component may comprise a bundle of capillaries. For example, the liquid aerosol-forming substrate storage component may comprise one or more of fibres, threads, and fine bore tubes.

The liquid aerosol-forming substrate storage component may comprise sponge-like or foam-like material. The structure of the liquid aerosol-forming substrate storage component may form a plurality of small bores or tubes, through which the liquid can be transported by capillary action.

The liquid aerosol-forming substrate storage component may comprise any suitable material or combination of materials. Suitable materials include but are not limited to: a sponge or foam material, ceramic- or graphite-based materials in the form of fibres or sintered powders, foamed metal or plastics material, a fibrous material, for example made of spun or extruded fibres, such as cellulose acetate, polyester, or bonded polyolefin, polyethylene, terylene or polypropylene fibres, nylon fibres or ceramic. The liquid aerosol-forming substrate storage component may comprise a ceramic material. The liquid aerosol-forming substrate storage component may have any suitable capillarity and porosity so as to be used with different liquid aerosol-forming substrates having different physical properties.

The heating element may comprise a fifth portion, the fifth portion being located in the reservoir. The term “reservoir”, unless explicitly stated otherwise, may be used to refer to a reservoir for storing liquid aerosol-forming substrate or a reservoir of liquid aerosol-forming substrate. The term “reservoir”, unless explicitly stated otherwise, may be used to refer to a reservoir for storing a free-flowing liquid aerosol forming substrate, or to a reservoir of free-flowing liquid aerosol-forming substrate.

The reservoir may be configured to store, or may store, at least 0.2, 0.5, or 1 millilitres of liquid aerosol-forming substrate. The reservoir may be configured to store, or may store, less than 2, 1.8, or 1.5 millilitres of liquid aerosol-forming substrate.

The heating element may be perforated. The heating element may be a mesh heating element. The heating element may comprise a mesh. The first portion, or the second portion, or both the first portion and the second portion may comprise perforations, or a mesh. The third portion, or the fourth portion, or both the third portion and the fourth portion may comprise perforations, or a mesh.

Advantageously, a mesh heating element or a heating element comprising a mesh may provide a large surface area in contact with the liquid aerosol-forming substrate. This large surface area may provide efficient vaporisation of the liquid aerosol-forming substrate.

The heater assembly may comprise a second heating element. Features described in relation to the first heating element may be applied to the second heating element. Equally, features described in relation to portions of the first heating element may apply to corresponding portions, or parts, of the second heating element. For example, one or more of the material and shape of the first heating element may apply to the second heating element. Alternatively, the second heating element may have a different shape, or form, than the heating element.

Advantageously, a second heating element may increase the rate of vaporisation of liquid aerosol-forming substrate in the liquid aerosol-forming substrate storage component. In addition, a distance between the first heating element and the second heating element may be selected so as to influence a temperature of a region of the liquid aerosol-forming substrate storage component in use. For example, a region of the liquid aerosol-forming substrate storage component in which the first heating element and the second heating element are closer together may reach a higher temperature than a region in which the first heating element and the second heating element are spaced further apart.

The second heating element may comprise a first part. The second heating element may comprise a second part. The second heating element may comprise a third part. The second heating element may comprise a fourth part. The second heating element may comprise a fifth part.

The second part may extend between the first part and the third part. The third part may extend between the second part and the fourth part.

The first part of the second heating element may be embedded in the liquid aerosol-forming substrate storage component. The second part of the second heating element may be not embedded in the liquid aerosol-forming substrate storage component. The third part of the second heating element may be embedded in the liquid aerosol-forming substrate storage component. The fourth part of the second heating element may be not embedded in the liquid aerosol-forming substrate storage component. The fifth part of the second heating element may be located in the reservoir.

This may advantageously create more areas of relatively higher temperature and more areas of relatively lower temperature in the liquid aerosol-forming substrate storage component.

The second heating element may weave into and out of the liquid aerosol-forming substrate storage component.

The second heating element may comprise one or more of curves, undulations, folds, and corrugations.

The second heating element may be spaced from the heating element in a direction transverse to a length of the heating element. The second heating element may be spaced from the heating element in a width direction of the heating element. The second heating element may be located adjacent to the first heating element.

The second heating element may be a mesh heating element. The second heating element may comprise a mesh.

The first heating element and the second heating element may not be electrically connected.

The first heating element may be configured to be inductively heated. The first heating element may be configured to be inductively heated.

The first heating element and the second heating element may be independently operable. It may be possible to resistively or inductively heat the first heating element without substantially resistively or inductively heating the second heating element. It may be possible to raise a temperature of first heating element without substantially raising a temperature of the second heating element. The first heating element and the second heating element may be connected to different power sources.

The first portion, or the second portion, or both the first portion and the second portion of the heating element may be configured to be heated to at least 50, 100, 150, 200, 250, 300, 350, or 400 degrees Celsius. In use, the first portion, or the second portion, or both the first portion and the second portion of the heating element may be heated to at least 50, 100, 150, 200, 250, 300, 350, or 400 degrees Celsius.

The third portion, or the fourth portion, or both the third portion and the fourth portion of the heating element may be configured to be heated to at least 50, 100, 150, 200, 250, 300, 350, or 400 degrees Celsius. In use, the third portion, or the fourth portion, or both the third portion and the fourth portion of the heating element may be heated to at least 50, 100, 150, 200, 250, 300, 350, or 400 degrees Celsius.

The fifth portion of the heating element may be configured to be heated, and may, in use, be heated, to at least 50, 100, 150, 200, 250, 300, 350, or 400 degrees Celsius. In use, the fifth portion of the heating element may be heated to at least 50, 100, 150, 200, 250, 300, 350, or 400 degrees Celsius.

The liquid aerosol-forming substrate storage component may be configured to store, or may store, at least 0.02, 0.05, 0.1, 0.2, or 0.5 millilitres of liquid aerosol-forming substrate.

According to another aspect of the present disclosure, there is provided a method of assembling a heater assembly. The heater assembly may be the heater assembly according to the present disclosure. The method may comprise providing a liquid aerosol-forming substrate storage component. The method may comprise providing a heating element comprising a first portion and a second portion. The method may comprise embedding the first portion of the heating element in the liquid aerosol-forming substrate storage component.

Where the heating element comprises the third portion, the method may comprise embedding the third portion of the heating element in the liquid aerosol-forming substrate storage component.

According to another aspect of the present disclosure, there is provided a cartridge. The cartridge may comprise a heater assembly according to the present disclosure.

The cartridge may be configured to engage with, and disengage from, an aerosol-generating device. The aerosol-generating device may comprise a power source. The power source may be configured to supply power to the heating element. The power source may be configured to supply power to the heating element only when the cartridge is engaged with the aerosol-generating device.

The cartridge may comprise an air inlet. The cartridge may comprise an air outlet. The air inlet may be in fluid communication with the air outlet. The heating element may be disposed downstream of the air inlet. The heating element may be disposed upstream of the air outlet. In use, this may allow air to flow in through the air inlet, then across, over, past, or through the heater assembly or heating element, then through the air outlet.

The cartridge may comprise a mouthpiece. The mouthpiece may comprise the air outlet. In use, when the cartridge is engaged with an aerosol-generating device, a user may puff on the mouthpiece of the cartridge. This may cause air to flow in through the air inlet, then across, over, past, or through the heater assembly or heating element, then through the air outlet.

Advantageously, providing an air flow across, over, past, or through the heater assembly or heating element may allow for entrainment of vapour formed by the heater assembly in the air flow.

The cartridge may comprise first and second electrical contacts electrically connected to the heating element. The electrical contacts may comprise one or more of tin, silver, gold, copper, aluminium, steel such as stainless steel, phosphor bronze, tin alloyed with antimony, tin alloyed with zirconium, tin alloyed with bismuth, or tin alloyed with other components improving resistance to organic acids.

The electrical contacts may be configured to form an electrical connection with corresponding electrical contacts on an aerosol-generating device when the cartridge is engaged with the aerosol-generating device.

The second portion, or the fourth portion, or both the second portion and the fourth portion of the heating element, may be located in an air flow path between the air inlet of the cartridge and the air outlet of the cartridge.

Advantageously, in use, this may increase the temperature of the air flow. Some users may prefer this. This may more accurately mimic the experience of smoking a conventional cigarette or cigar.

According to another aspect of the present disclosure, there is provided an aerosol-generating system. The system may comprise a heater assembly according to the present disclosure.

The aerosol-generating system may comprise a cartridge according to the present disclosure.

The system may comprise an aerosol-generating device. The system may comprise a cartridge comprising the heater assembly.

The cartridge may be configured to engage with the aerosol-generating device. The cartridge may be configured to disengage from the aerosol-generating device.

The aerosol-generating system, for example the aerosol-generating device of the aerosol-generating system, may comprise a power supply, such as a battery. The power supply may be configured to supply power to the heating element. This may be to heat the heating element. The power supply may be configured to supply power to the heating element only when the cartridge is engaged with the aerosol-generating device.

The aerosol-generating device may comprise a controller. The controller may be configured to control supply of power from the power supply. Thus, the controller may control heating of the heating element.

The power supply may be configured to supply power to the heating element to resistively heat the heating element. The power supply may be configured to supply power to the heating element to inductively heat the heating element.

The aerosol-generating device may be configured to engage to, and disengage from, the cartridge via a snap-fit connection, corresponding screw threads or any other suitable means. The aerosol-generating device may be configured to receive at least a portion of the cartridge. For example, the aerosol-generating device may comprise a chamber configured to receive at least a portion of the cartridge.

The aerosol-generating device may comprise an air inlet. The aerosol-generating device may comprise an air outlet. When the aerosol-generating device is engaged with the cartridge, the air outlet of the aerosol-generating device may be in fluid communication with the air inlet of the cartridge.

The power supply may be electrically connected to first and second electrical contacts of the device. These first and second electrical contacts may be configured to form an electrical connection with corresponding first and second electrical contacts on the cartridge when the cartridge is engaged with the device. These corresponding first and second electrical contacts on the cartridge may be electrically connected to the heating element. Thus, the power supply may be configured to supply power to the heating element by passing a current through the heating element.

The cartridge or the aerosol-generating device may comprise an inductor, for example an induction coil. The heating element may be, or may comprise, a susceptor material.

The power supply may be configured to pass a current, such as a high frequency alternating current, through the inductor such that the inductor generates a fluctuating electromagnetic field. This, in turn, may generate eddy currents and hysteresis losses in the susceptor material. This may cause the susceptor material to heat up. Thus, the power supply, using the inductor, may be configured to inductively heat the heating element.

Suitable susceptor materials include those mentioned earlier with reference to the heater assembly according to the present disclosure.

The inductor may be an induction coil. The inductor may be located in a cartridge comprising the heater assembly. The inductor may be disposed around the heating element, or around part of the heating element. For example, the inductor may be an induction coil and may spiral around the heating element, or around part of the heating element.

The inductor may be electrically connected to electrical contacts on the cartridge. When the cartridge is engaged with an aerosol-generating device, these electrical contacts may be electrically connected to corresponding electrical contacts on the device which are electrically connected to a power supply in the device. When the cartridge is engaged with the device, the power supply of the device may be configured to pass a current through the inductor to generate a fluctuating electromagnetic field and thereby heat the susceptor material of the heating element.

The inductor, such as an induction coil, may be located in the aerosol-generating device. The inductor may be electrically connected to a power supply of the aerosol-generating device. The aerosol-generating device may be configured to engage with the heater assembly or a cartridge comprising the heater assembly. For example, the device may comprise a chamber for receiving at least a portion of the heater assembly, or at least a portion of the cartridge comprising the heater assembly. The induction coil may be disposed around at least part of this chamber. For example, the induction coil may spiral around at least part of the chamber. As such, when the heater assembly, or the cartridge comprising the heater assembly, is engaged with the device, the induction coil may be disposed around, or spiral around, the heating element or part of the heating element. When at least a portion of the heater assembly, or at least a portion of a cartridge comprising the heater assembly, is received within the chamber of the device, the power supply of the device may be configured to pass a current through the inductor to generate a fluctuating electromagnetic field and thereby heat the susceptor material of the heating element.

As mentioned above, inductive heating may advantageously allow production of a cartridge that is simple, inexpensive and robust. In addition, inductive heating may provide improved energy conversion compared to resistive heating.

The aerosol-generating system may be a smoking system, for example an electrically operated smoking system. The aerosol-generating system may be for recreational use. In use, the aerosol-generating system may be suitable for delivering, or configured to deliver, nicotine to a user.

The aerosol-generating system may be portable. The aerosol-generating system may have a size comparable to a conventional cigar or cigarette. The smoking system may have a total length between 30 millimetres and 200 millimetres. The smoking system may have an external diameter between 5 millimetres and 30 millimetres. As used herein, the term “aerosol” refers to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosol-forming substrate” refers to a substrate capable of releasing volatile compounds that can form an aerosol. The volatile compounds may be released by heating or combusting the aerosol-forming substrate.

The aerosol-forming substrate may comprise a plurality of compounds. The compounds may have different boiling points. For example, the aerosol-forming substrate may comprise a first compound with a first boiling point at atmospheric pressure and a second compound with a second boiling point at atmospheric pressure, the first boiling point being greater than the second boiling point.

The aerosol-forming substrate may comprise an aerosol former. As used herein, the term “aerosol-former” refers to any suitable compound or mixture of compounds that, in use, facilitates formation of an aerosol, for example a stable aerosol that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

The aerosol-forming substrate may comprise nicotine. The aerosol-forming substrate may comprise water. The aerosol-forming substrate may comprise glycerol, also referred to as glycerine, which has a higher boiling point than nicotine. The aerosol-forming substrate may comprise propylene glycol. The aerosol-forming substrate may comprise plant-based material. The aerosol-forming substrate may comprise homogenised plant-based material. The aerosol-forming substrate may comprise tobacco. The aerosol-forming substrate may comprise a tobacco-containing material. The tobacco-containing material may contain volatile tobacco flavour compounds. These compounds may be released from the aerosol-forming substrate upon heating. The aerosol-forming substrate may comprise homogenised tobacco material. The aerosol-forming substrate may comprise other additives and ingredients, such as flavourants.

As used herein, the term “liquid aerosol-forming substrate” is used to refer to an aerosol-forming substrate in condensed form. Thus, the “liquid aerosol-forming substrate” may be, or may comprise, one or more of a liquid, gel, or paste. If the liquid aerosol-forming substrate is, or comprises, a gel or paste, the gel or paste may liquidise upon heating. For example, the gel or paste may liquidise upon heating to a temperature of less than 50, 75, 100, 150, or 200 degrees Celsius.

As used herein, the term “heating element” refers to an element of a heater, the element being configured to be heated. For example, the term “heating element” may refer to an element configured to be heated to at least 50, 100, 150, 200, 250, 300, 350, or 400 degrees Celsius. The heating element, or parts thereof, may be configured to be resistively heated. Alternatively, or in addition, the heating element, or parts thereof, may be configured to be inductively heated.

As used herein, the term “embedded” may be used to mean surrounded, enveloped, enclosed, circumscribed, or encircled. In addition, where a first component is “embedded” in a second component, this may imply that the first component is in contact with the second component. For example, where a portion of a heating element is described as embedded in a component, this may mean that this portion of the heating element is encircled by, and in contact with, the component.

The invention is defined in the claims. However, below there is provided a non-exhaustive list of non-limiting examples. Any one or more of the features of these examples may be combined with any one or more features of another example, embodiment, or aspect described herein.

Example Ex1: A heater assembly for use in an aerosol-generating system, the heater assembly comprising:
a liquid aerosol-forming substrate storage component; and
a heating element comprising a first portion and a second portion,
wherein the first portion of the heating element is embedded in the liquid aerosol-forming substrate storage component and the second portion of the heating element is not embedded in the liquid aerosol-forming substrate storage component.

Example Ex2: A heater assembly according to Example Ex1, wherein the heating element comprises a third portion and a fourth portion, wherein the third portion of the heating element is embedded in the liquid aerosol-forming substrate storage component and the fourth portion is not embedded in the liquid aerosol-forming substrate storage component.

Example Ex3: A heater assembly according to Example Ex2, wherein the second portion of the heating element extends between the first portion and the third portion.

Example Ex4: A heater assembly according to Example Ex2 or Example Ex3, wherein the third portion of the heating element extends between the second portion and the fourth portion.

Example Ex5: A heater assembly according to any of Examples Ex2 to Ex4, wherein the third portion and the fourth portion are configured to be resistively heated.

Example Ex6: A heater assembly according to any of Examples Ex2 to Ex5, wherein the third portion and the fourth portion comprise an electrically resistive material.

Example Ex7: A heater assembly according to any preceding Example, wherein the first portion and the second portion are configured to be resistively heated.

Example Ex8: A heater assembly according to any preceding Example, wherein the first portion and the second portion comprise an electrically resistive material.

Example Ex9: A heater assembly according to any of Examples Ex2 to Ex4, wherein the third portion and the fourth portion are configured to be inductively heated.

Example Ex10: A heater assembly according to any of Examples Ex2 to Ex4, or Ex9, wherein the third portion and the fourth portion comprise a susceptor material.

Example Ex11: A heater assembly according to any of Examples Ex1 to Ex4, Ex9, or Ex10, wherein the first portion and the second portion are configured to be inductively heated.

Example Ex12: A heater assembly according to any of Examples Ex1 to Ex4, Ex9, Ex10, or Ex11, wherein the first portion and the second portion comprise a susceptor material.

Example Ex13: A heater assembly according to any preceding Example, wherein the heating element comprises a strip of material.

Example Ex14: A heater assembly according to any preceding Example, wherein a cross-section of the heating element varies along a length of the heating element.

Example Ex15: A heater assembly according to any preceding Example, wherein a minimum cross-sectional area along a length of the heating element is at least 10 percent less than a maximum cross-sectional area along a length of the heating element.

Example Ex16: A heater assembly according to any preceding Example, wherein a width or a thickness or both the width and the thickness of the heating element vary along a length of the heating element.

Example Ex17: A heater assembly according to any preceding Example, wherein the heating element weaves into and out of the liquid aerosol-forming substrate storage component.

Example Ex18: A heater assembly according to any preceding Example, wherein the heating element comprises one or more of curves, undulations, folds, and corrugations.

Example Ex19: A heater assembly according to any preceding Example, wherein the heating element comprises one or more of irregular undulations and irregular corrugations along a length of the heating element.

Example Ex20: A heater assembly according to any preceding Example, wherein a frequency of undulations or corrugations of the heating element varies along a length of the heating element.

Example Ex21: A heater assembly according to any preceding Example, wherein an amplitude of undulations or corrugations of the heating element varies along a length of the heating element.

Example Ex22: A heater assembly according to any preceding Example, comprising a reservoir for storing liquid aerosol-forming substrate.

Example Ex23: A heater assembly according to Ex22, wherein the reservoir is in fluid communication with the liquid aerosol-forming substrate storage component.

Example Ex24: A heater assembly according to Ex22 or Ex23, wherein the heating element comprises a fifth portion, the fifth portion being located in the reservoir.

Example Ex25: A heater assembly according to Ex22, Ex23 or Ex24, wherein the reservoir comprises at least 1 millilitres of liquid aerosol-forming substrate.

Example Ex26: A heater assembly according to any preceding Example, comprising a second heating element.

Example Ex27: A heater assembly according to Ex26, wherein the second heating element weaves into and out of the liquid aerosol-forming substrate storage component.

Example Ex28: A heater assembly according to Ex26 or Ex27, wherein the second heating element comprises one or more of curves, undulations, folds, and corrugations.

Example Ex29: A heater assembly according to any of Examples Ex26 to Ex28, wherein the second heating element is spaced from the heating element in a direction transverse to a length of the heating element.

Example Ex30: A heater assembly according to any of Examples Ex26 to Ex29, wherein the second heating element is a mesh heating element.

Example Ex31: A heater assembly according to any preceding Example, wherein, in use, both the first portion and the second portion are heated to at least 50 degrees Celsius.

Example Ex32: A heater assembly according to any preceding Example, wherein the heating element is a mesh heating element.

Example Ex33: A heater assembly according to any preceding Example, wherein the liquid aerosol-forming substrate storage component comprises a capillary retention material.

Example Ex34: A heater assembly according to any preceding Example, wherein the liquid aerosol-forming substrate storage component is configured to store at least 0.05 millilitres of liquid aerosol-forming substrate.

Example Ex35: A heater assembly according to any preceding Example, wherein at least 0.05 millilitres of liquid aerosol-forming substrate is stored in the liquid aerosol-forming substrate storage component.

Example Ex36: A cartridge comprising a heater assembly according to any preceding Example.

Example Ex37: A method of assembling a heater assembly according to any of Examples Ex1 to Ex35, the method comprising:
providing the liquid aerosol-forming substrate storage component;
providing the heating element comprising the first portion and the second portion; and
embedding the first portion of the heating element in the liquid aerosol-forming substrate storage component.

Example Ex38: An aerosol-generating system comprising a heater assembly according to any of Examples Ex1 to Ex35.

Example Ex39: An aerosol-generating system according to Ex38, the system comprising an aerosol-generating device and a cartridge comprising the heater assembly.

Example Ex40: An aerosol-generating system according to Ex39, wherein the cartridge is configured to engage with, and disengage from, the aerosol-generating device.

Example Ex41: An aerosol-generating system according to any of Examples Ex38, Ex39, or Ex40, wherein the aerosol-generating system comprises a power supply configured to supply power to the heating element to heat the heating element.

Example Ex42: An aerosol-generating system according to Ex39 or Ex40, wherein the aerosol-generating device comprises a power supply configured to supply power to the heating element to heat the heating element.

Example Ex43: An aerosol-generating system according to Ex41 or Ex42, wherein the power supply is configured to supply power to the heating element to resistively heat the heating element.

Example Ex44: An aerosol-generating system according to Ex41 or Ex42, wherein the power supply is configured to supply power to the heating element to inductively heat the heating element.

Example Ex45: An aerosol-generating system according to any of Examples Ex38 to Ex44, wherein the aerosol-generating system has a total length of between 30 millimetres and 200 millimetres.

Example Ex46: An aerosol-generating system according to any of Examples Ex38 to Ex45, wherein the aerosol-generating system has an external diameter of between 5 millimetres and 30 millimetres.

Example Ex47: An aerosol-generating system according to any of Examples Ex38 to Ex46, wherein the aerosol-generating system is portable.

Example Ex48: An aerosol-generating system according to any of Examples Ex38 to Ex47, wherein the aerosol-generating system is a smoking system.

Examples will now be further described with reference to the figures in which:

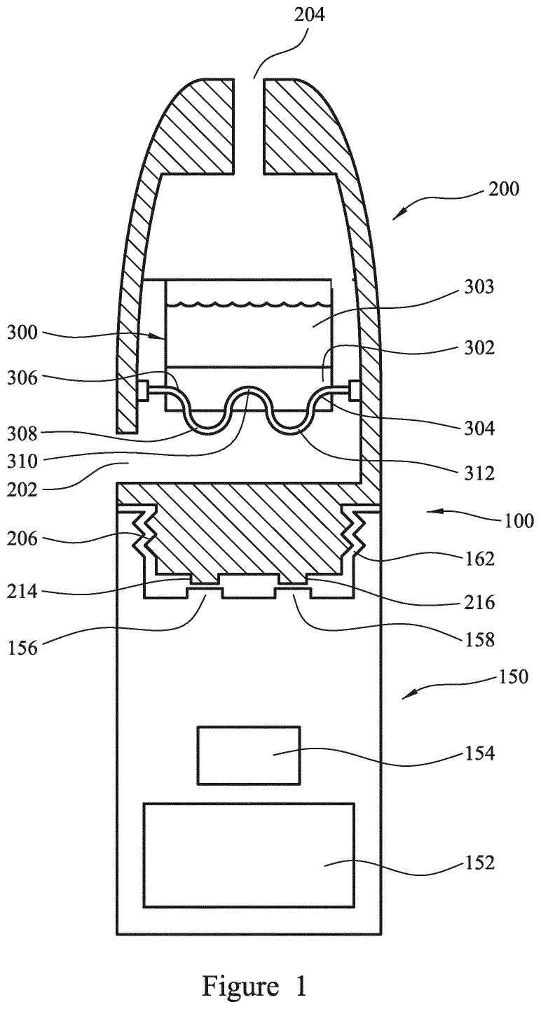

FIG. 1 shows a schematic, cross-sectional view of a first aerosol-generating system comprising a cartridge incorporating a first heater assembly;

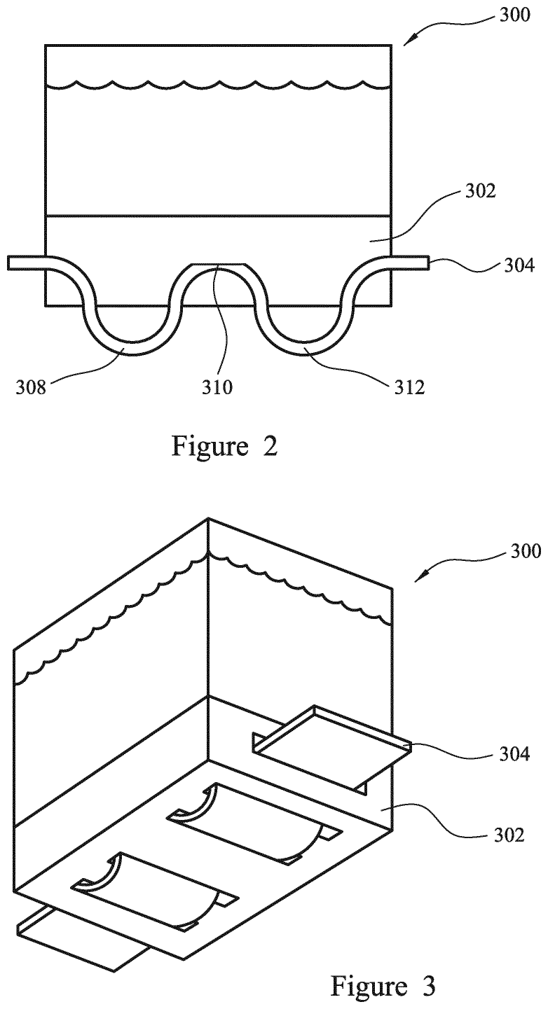

FIG. 2 shows a schematic, cross-sectional view of the first heater assembly;

FIG. 3 shows a schematic, perspective view of the first heater assembly;

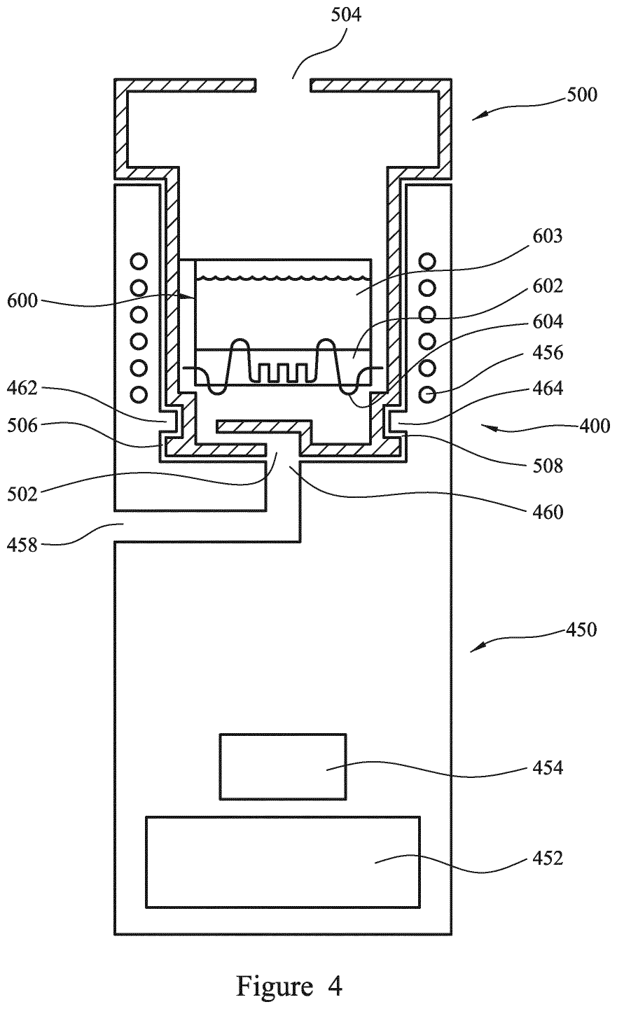

FIG. 4 a schematic, cross-sectional view of a second aerosol-generating system comprising a cartridge incorporating a second heater assembly;

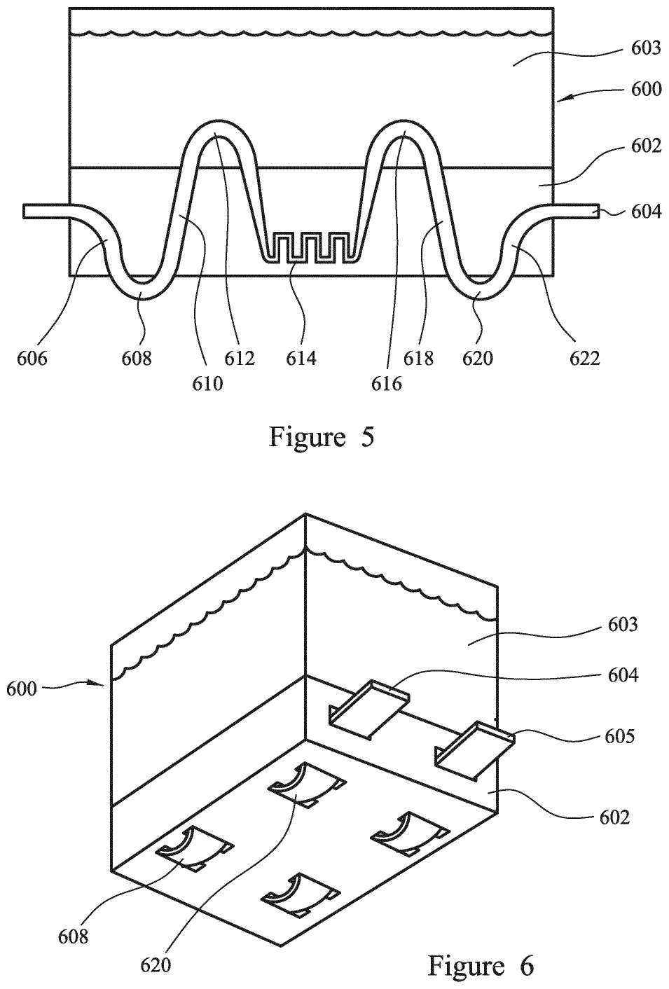

FIG. 5 shows a schematic, cross-sectional view of a second heater assembly; and

FIG. 6 shows a schematic, perspective view of the second heater assembly.

FIG. 1 shows a schematic, cross-sectional view of a first aerosol-generating system 100. The aerosol-generating system 100 comprises an aerosol-generating device 150 and a cartridge 200. In this example, the aerosol-generating system 100 is an electrically operated smoking system.

The aerosol-generating device 150 is portable and has a size comparable to a conventional cigar or cigarette. The device 150 comprises a battery 152, such as a lithium iron phosphate battery, and a controller 154 electrically connected to the battery 152. The device 150 also comprises two electrical contacts 156, 158 which are electrically connected to the battery 152. This electrical connection is a wired connection and is not shown in FIG. 1.

The cartridge 200 comprises first and second electrical contacts 214, 216, an air inlet 202, an air outlet 204, and a first heater assembly 300. The air inlet 202 is in fluid communication with the air outlet 204. The heater assembly 300 is positioned downstream of the air inlet 202 and upstream of the air outlet 204. The heater assembly 300 comprises a liquid aerosol-forming substrate storage component 302 in fluid communication with a reservoir 303 of liquid aerosol-forming substrate. The heater assembly 300 also comprises a heating element 304. The first and second electrical contacts 214, 216 are electrically connected to the heating element 304.

In this system 100, the liquid aerosol-forming substrate comprises around 74% by weight glycerine, 24% by weight propylene glycol, and 2% by weight nicotine, though any suitable substrate could be used. At atmospheric pressure, nicotine has a boiling point of around 247 degrees centigrade, glycerine has a boiling point of around 290 degrees centigrade and propylene glycol has a boing point of around 188 degrees centigrade. Thus, when initially heating this liquid aerosol-forming substrate to form an aerosol, some systems may undesirably vaporise a disproportionately large amount of propylene glycol (which has the lowest boiling point of the compounds forming the substrate). This may lead to a less desirable aerosol being delivered to the user, such as an aerosol comprising a smaller proportion of nicotine than desired. This may also undesirably change the relative proportions of the compounds in the substrate over a longer time period. The present invention may eliminate or at least reduce these undesirable effects.

The heating element 304 is a strip of material. In this example, the material is stainless steel, though any suitable material could be used. The heating element 304 comprises a first portion 306, a second portion 308, a third portion 310, and a fourth portion 312. The second portion 308 extends between the first portion 306 and the third portion 310. The third portion 310 extends between the second portion 308 and the fourth portion 312. The first portion 306 and the third portion 310 are embedded in the liquid aerosol-forming substrate storage component 302. The second portion 308 and the fourth portion 312 are not embedded in the liquid aerosol-forming substrate storage component 302. In the example shown in FIG. 1, the second portion 308 and the fourth portion 312 are located in an air flow path between the air inlet 202 and the air outlet 204 of the cartridge 200.

In FIG. 1, the aerosol-generating device 150 is engaged with the cartridge 200. In this example, the cartridge 200 is engaged with the aerosol-generating device 150 via a screw thread 206 of the cartridge 200 mated with a corresponding screw thread 162 of the aerosol-generating device 150.

The liquid aerosol-forming substrate storage component 302 in this example is a capillary material having a fibrous structure. In the example shown in FIG. 1, the capillary material is formed form polyester, though any suitable material could be used.

In use, a user puffs on the air outlet 204 of the cartridge 200. At the same time, the user presses a button (not shown) on the aerosol-generating device 150. Pressing this button sends a signal to the controller 154, which results in power being supplied from the battery 152 to the heating element 304 via the electrical contacts 156, 158 of the device and the electrical contacts 214, 216 of the cartridge. This causes a current to flow through the heating element 304, thereby resistively heating the heating element 304. In other examples, an air flow sensor, or pressure sensor, is located in the cartridge 200 and electrically connected to the controller 154. The air flow sensor, or pressure sensor, detects that a user is puffing on the air outlet 204 of the cartridge 200 and sends a signal to the controller 154 to provide power to the heating element 304. In these examples, there is therefore no need for the user to press a button to heat the heating element 304.

As the heating element 304 is heated, areas of relatively higher temperature and areas of relatively lower temperature are created in the liquid aerosol-forming substrate storage component 302. Areas of relatively lower temperature may be created in areas where the heating element 304 is closer to the reservoir 303 of liquid aerosol-forming substrate. This is because heat from the heating element 304 in these areas is dissipated into the reservoir 303 more quickly. Areas of relatively lower temperature may be created in areas which are further from the heating element. Areas of relatively higher temperature may be created due to the shape of the heating element. For example, the heating element may be shaped such that there is a greater volume, or greater surface area, of the heating element present in a given volume in a first location in the liquid aerosol-forming substrate storage component than in the same given volume in a second location in the liquid aerosol-forming substrate storage component. In this case, the average temperature of the liquid aerosol-forming substrate in the first location may be greater than the average temperature of the liquid aerosol-forming substrate in the second location.

The creation of areas of higher temperature and areas of lower temperature causes compounds of the liquid aerosol-forming substrate with higher boiling points and lower boiling points in the liquid aerosol-forming substrate storage component 302 to be vaporised simultaneously. The creation of areas of higher temperature and areas of lower temperature also causes compounds of the liquid aerosol-forming substrate with higher boiling points and lower boiling points in the liquid aerosol-forming substrate storage component 302 to be vaporised at desirable rates.

As the user puffs on the air outlet 204 of the cartridge 200, air is drawn into the air inlet 202. This air then travels across the heater assembly 300 and towards the air outlet 204. This flow of air entrains the vapour formed by the heating element 304 heating liquid aerosol-forming substrate in the liquid aerosol-forming substrate storage component 302. Due to the creation of areas of higher temperature and areas of lower temperature, as explained above, the vapour comprises desirable proportions of different compounds having different boiling points. This entrained vapour then cools and condenses to form an aerosol. This aerosol is then delivered to the user via the air outlet 204. As liquid aerosol-forming substrate in the liquid aerosol-forming substrate storage component 302 is heated, vaporised, and entrained in the air flow, liquid aerosol-forming substrate from the reservoir 303 travels into the liquid aerosol-forming substrate storage component 302. This liquid aerosol-forming substrate from the reservoir 303 effectively replaces the vaporised liquid aerosol-forming substrate. The liquid aerosol-forming substrate from the reservoir 303 may be drawn into the liquid aerosol-forming substrate storage component 302, at least partly, by capillary action. This is because the liquid aerosol-forming substrate storage component 302 is a capillary material having a fibrous structure.

FIG. 2 shows a schematic, cross-sectional view of the first heater assembly 300. The width of the heating element 304 which, in FIG. 2, is in a direction into the page, could vary but, in the example shown in FIG. 2, is constant. However, as shown in FIG. 2, the thickness of the heating element 304 is not constant. Rather, the thickness gradually decreases from the second portion 308 to the third portion 310 and then gradually increases from the third portion 310 to the fourth portion 312. The minimum thickness of the heating element 304 is in the third portion 310, which is embedded in the liquid aerosol-forming substrate storage component 302. This minimum thickness of the heating element 304 is around 50 percent of the maximum thickness of the heating element in the first portion 306. Thus, the resistance of the third portion 310 is greater than the resistance of other portions, and, in use, the third portion 310 will be resistively heated to a greater temperature than other portions. This may advantageously increase the temperature of liquid aerosol-forming substrate close to the third portion 310 of the heating element 304.

FIG. 3 shows a schematic, perspective view of the first heater assembly 300. As shown in FIG. 3, the heating element 304 comprises curves and weaves into and out of the liquid aerosol-forming substrate storage component 302. Ends of the heating element 304 extend out of the liquid aerosol-forming substrate storage component 302 to enable easy electrical connection to electrical contacts (not shown in FIG. 3) of the cartridge 200.

FIG. 4 shows a schematic, cross-sectional view of a second aerosol-generating system 400. The aerosol-generating system 400 comprises an aerosol-generating device 450 and a cartridge 500 incorporating a second heater assembly 600. In this example, the aerosol-generating system 400 is an electrically operated smoking system.

The aerosol-generating device 450 is portable and has a size comparable to a conventional cigar or cigarette. The device 450 comprises a battery 452, such as a lithium iron phosphate battery, and a controller 454 electrically connected to the battery 452. The device 450 also comprises an induction coil 456 electrically connected to the battery 452. The device 450 also comprises an air inlet 458 and an air outlet 460 in fluid communication with the air inlet 458.

The cartridge 500 comprises an air inlet 502, an air outlet 504, and a second heater assembly 600. The air inlet 502 is in fluid communication with the air outlet 504. The heater assembly 600 is positioned downstream of the air inlet 502 and upstream of the air outlet 504. When the cartridge 500 is engaged with the aerosol-generating device 450, as shown in FIG. 4, the air outlet 460 of the device 450 is adjacent to the air inlet 502 of the cartridge 500. Thus, in use, when a user puffs on the air outlet 504 of the cartridge 500, air flows through the air inlet 458 of the device 450, then through the air outlet 460 of the device 450, then through the air inlet 502 of the cartridge 500, then past the heater assembly 600, then through the air outlet 504 of the cartridge 500.

In FIG. 4, the cartridge 500 is engaged with the aerosol-generating device 450. In this example, the cartridge 500 is engaged with the aerosol-generating device 450 via apertures 506, 508 which form a snap-fit connection with corresponding protrusions 462, 464 on the aerosol-generating device 450.

The heater assembly 600 comprises a first heating element 604, a second heating element (not visible in FIG. 4), a reservoir 603 of liquid aerosol-forming substrate, and a liquid aerosol-forming substrate storage component 602 in fluid communication with the reservoir 603. The second heating element 605 is not visible in FIG. 4, but is visible in FIG. 6.

In this system 400, the liquid aerosol-forming substrate comprises around 98% by weight glycerine and 2% by weight nicotine, though any suitable substrate could be used. At atmospheric pressure, nicotine has a boiling point of around 247 degrees centigrade and glycerine has a boiling point of around 290 degrees centigrade. Thus, when initially heating this liquid aerosol-forming substrate to form an aerosol, some systems may undesirably vaporise a disproportionately large amount of nicotine (which has the lowest boiling point of the compounds forming the substrate). This may lead to a less desirable aerosol being delivered to the user. This may also undesirably change the relative proportions of the compounds in the substrate over a longer time period. The present invention may eliminate or at least reduce these undesirable effects.

The first heating element 604 comprises a strip of a susceptor material. In this example, the susceptor material is aluminium, though any suitable susceptor material could be used. The first heating element 604 comprises a plurality of portions embedded in the liquid aerosol-forming substrate storage component 602, and a plurality of portions not embedded in the liquid aerosol-forming substrate storage component 602. Of the portions which are not embedded in the liquid aerosol-forming substrate storage component 602, two are located in the reservoir 603.

In the example shown in FIG. 4, the second heating element 605 is identical to the first heating element 604, though two (or more) different heating elements could be used. The second heating element 605 is located adjacent to the first heating element 604.

The liquid aerosol-forming substrate storage component 602 in this example is a capillary material having a fibrous structure. The capillary material is formed form polyester, though any suitable material could be used.

In use, a user puffs on the air outlet 504 of the cartridge 500. At the same time, the user presses a button (not shown) on the aerosol-generating device 450. Pressing this button sends a signal to the controller 454, which results in the battery 452 supplying a high frequency electrical current to the induction coil 456. This causes the induction coil 456 to create a fluctuating electromagnetic field. The first heating element 604 and the second heating element 605 are positioned within this field. Thus, this fluctuating electromagnetic field generates eddy currents and hysteresis losses in the first heating element 604 and the second heating element 605. The first heating element 604 and the second heating element 605 are therefore inductively heated. In other examples, an air flow sensor, or pressure sensor, is located in the device 450 and electrically connected to the controller 454. The air flow sensor, or pressure sensor, detects that a user is puffing on the air outlet 504 of the cartridge 500 and sends a signal to the controller 454 to supply the high frequency electrical current to the induction coil 456, thereby heating the first heating element 604 and the second heating element 605. In these examples, there is therefore no need for the user to press a button to heat the first heating element 604 and the second heating element 605.

As the first heating element 604 and the second heating element 605 are heated, areas of relatively higher temperature and areas of relatively lower temperature are created in the liquid aerosol-forming substrate storage component 602. Areas of lower temperature may be created in areas where the heating element 604 is closer to the reservoir 603 of liquid aerosol-forming substrate. This is because heat from the heating element 604 in these areas is dissipated into the reservoir 603 more quickly. Areas of relatively lower temperature may be created in areas which are further from the heating element. Areas of relatively higher temperature may be created due to the shape of the heating element. For example, the heating element may be shaped such that there is a greater volume, or greater surface area, of the heating element present in a given volume in a first location in the liquid aerosol-forming substrate storage component than in the same given volume in a second location in the liquid aerosol-forming substrate storage component. In this case, the average temperature of the liquid aerosol-forming substrate in the first location may be greater than the average temperature of the liquid aerosol-forming substrate in the second location.

The creation of areas of higher temperature and areas of lower temperature causes compounds of the liquid aerosol-forming substrate with higher boiling points and lower boiling points in the liquid aerosol-forming substrate storage component 602 to be vaporised simultaneously. The creation of areas of higher temperature and areas of lower temperature also causes compounds of the liquid aerosol-forming substrate with higher boiling points and lower boiling points in the liquid aerosol-forming substrate storage component 302 to be vaporised at desirable rates.

As the user puffs on the air outlet 504 of the cartridge 500, air is drawn into the air inlet 458 of the device 450, then through the air outlet 460 of the device 450, then through the air inlet 502 of the cartridge 500. This air then travels around the heater assembly 600 and towards the air outlet 504. This flow of air entrains the vapour formed by heating of the liquid aerosol-forming substrate by the first heating element 604 and the second heating element 605. Due to the creation of areas of higher temperature and areas of lower temperature, as explained above, the vapour comprises desirable proportions of different compounds having different boiling points. This entrained vapour then cools and condenses to form an aerosol. This aerosol is then delivered to the user via the air outlet 504.

FIG. 5 shows a schematic, cross-sectional view of a second heater assembly 600.

The first heating element 604 comprises a first portion 606, a second portion 608, a third portion 610, a fourth portion 612, a fifth portion 614, a sixth portion 616, a seventh portion 618, an eighth portion 620, and a ninth portion 622. The first portion 606, the third portion 610, the fifth portion 614, the seventh portion 618, and the ninth portion 622 are embedded in the liquid aerosol-forming substrate storage component 602. The second portion 608, fourth portion 612, the sixth portion 616, and the eighth portion 620 are not embedded in the liquid aerosol-forming substrate storage component 602. The second portion 608 and the eighth portion 620 are located in an air flow path between the air inlet 502 and the air outlet 504 of the cartridge 500. The fourth portion 612 and the sixth portion 616 are located in the reservoir 603 of liquid aerosol-forming substrate.

In FIG. 5, the varying thickness of the first heating element 604 can be seen. The central section of the fifth portion 614 has a reduced thickness compared with the rest of the first heating element 604. Specifically, the thickness in the central section of the fifth portion 616 has a thickness of around 30 percent of the thickness of the rest of the first heating element 604. As shown in FIG. 5, the fifth portion 614 also comprises corrugations. The region of the liquid aerosol-forming substrate storage component 602 around the fifth portion 614 may be raised to a relatively higher temperature than other regions of the liquid aerosol-forming substrate storage component 602. This is because the fifth portion 614 of the heating element 604 being thinner may result in the fifth portion 614 being inductively heated to a higher temperature than other portions of the heating element 604. Alternatively, or in addition, the corrugations in the fifth portion 614 mean that the region of the liquid aerosol-forming substrate storage component 602 around the fifth portion 614 comprises a greater volume and a greater surface area of the heating element 604 than other regions of the liquid aerosol-forming substrate storage component 602 with a similar size. Thus, more heat may be transferred from the heating element 604 into the region of the liquid aerosol-forming substrate storage component 602 around the fifth portion 614 than into other regions.

FIG. 6 shows a schematic, perspective view of the second heater assembly 600. In FIG. 6, the second heating element 605 is visible. The second heating element 605 is identical to the first heating element 604 and is located adjacent to the first heating element 604. The second heating element 605 therefore similarly has portions embedded in the liquid aerosol-forming substrate storage component 602, portions located in the reservoir 603, and portions located in an air flow path between the air inlet 502 and the air outlet 504 of the cartridge 500. In FIG. 6, the second portion 608 and the eighth portion 620 of the first heating element 604 are also visible.

The heater assemblies described herein may provide areas of higher temperature, and areas of lower temperature, in the liquid aerosol-forming substrate storage component. Alternatively, or in addition, the heater assemblies may provide areas which increase in temperature at a greater rate, and areas which increase in temperature at a lesser rate, in the liquid aerosol-forming substrate storage component. Advantageously, as explained above, this may lead to liquid aerosol-forming substrate compounds with higher boiling points and lower boiling points being vaporised simultaneously at desirable rates.

For the purpose of the present description and appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-13. (canceled)

14. A heater assembly for an aerosol-generating system, the heater assembly comprising:
a liquid aerosol-forming substrate storage component;
a reservoir of free-flowing liquid aerosol-forming substrate, the reservoir being in fluid communication with the liquid aerosol-forming substrate storage component; and
a heating element comprising a first portion, a second portion, and a further portion,
wherein the first portion of the heating element is embedded in the liquid aerosol-forming substrate storage component, the second portion of the heating element is not embedded in the liquid aerosol-forming substrate storage component, and the further portion of the heating element is located in the reservoir.

15. The heater assembly according to claim 14,
wherein the heating element comprises a third portion and a fourth portion, and
wherein the third portion of the heating element is embedded in the liquid aerosol-forming substrate storage component and the fourth portion is not embedded in the liquid aerosol-forming substrate storage component.

16. The heater assembly according to claim 15, wherein the second portion of the heating element extends between the first portion and the third portion, and the third portion of the heating element extends between the second portion and the fourth portion.

17. The heater assembly according to claim 14, wherein the heating element further comprises a strip of material having a length, a width perpendicular to the length, and a thickness perpendicular to the length and the width, the length being greater than the width and greater than the thickness.

18. The heater assembly according to claim 14, wherein a cross-section of the heating element varies along a length of the heating element.

19. The heater assembly according to claim 14, wherein the heating element extends between a first end and a second end, and the heating element has a first cross-sectional area at a first point between the first end and the second end, a second cross-sectional area at a second point between the first point and the second end, and a third cross-sectional area at a third point between the second point and the second end, each of the first cross-sectional area and the third cross-sectional area being greater than, or less than, the second cross-sectional area.

20. The heater assembly according to claim 14, wherein the heating element weaves into and out of the liquid aerosol-forming substrate storage component.

21. The heater assembly according to claim 14, wherein the heating element further comprises one or more of curves, undulations, folds, and corrugations.

22. The heater assembly according to claim 14, further comprising a second heating element.

23. The heater assembly according to claim 22,
wherein the second heating element comprises a first part and a second part, and
wherein the first part of the second heating element is embedded in the liquid aerosol-forming substrate storage component and the second part of the second heating element is not embedded in the liquid aerosol-forming substrate storage component.

24. The heater assembly according to claim 14, wherein both the first portion and the second portion are heated to at least 50 degrees Celsius.

25. An aerosol-generating system comprising a heater assembly according to claim 14.

26. The aerosol-generating system according to claim 25,
further comprising an aerosol-generating device and a cartridge comprising the heater assembly,
wherein the cartridge is configured to engage with, and disengage from, the aerosol-generating device.
